(19) United States
(12) Patent Application Publication
(10) Pub. No.: US 2019/0213610 A1
(43) Pub. Date: Jul. 11, 2019

(54) EVALUATION DEVICE AND EVALUATION METHOD

(71) Applicant: Panasonic Intellectual Property Management Co., Ltd., Csaka (JP)

(72) Inventors: YOSHIYUKI OKIMOTO, Nara (JP); HIDEHIKO SHIN, Osaka (JP); TOMOAKI ITOH, Tokyo (JP); TAKAYUKI FUKUI, Osaka (JP); KOICHIRO YAMAGUCHI, Osaka (JP)

(21) Appl. No.: 16/352,338

(22) Filed: Mar. 13, 2019

Related U.S. Application Data
(63) Continuation of application No. PCT/JP2017/031699, filed on Sep. 4, 2017.

(30) Foreign Application Priority Data
Sep. 30, 2016 (JP) 2016-193297

(51) Int. Cl. G06Q 30/02; G06Q 10/06; G06Q 30/06

(52) U.S. Cl. CPC G06Q 30/0201; G06Q 30/0639; G06Q 10/06393; G06Q 10/0637

(57) ABSTRACT

An evaluation device evaluates a placement position of an item placed on a shelf in a shop, and includes: an obtaining unit that obtains traffic line information indicating a plurality of persons passing in front of the shelf and purchased-item information indicating one or more purchased items, the one or more purchased items being purchased in the shop by the plurality of persons; and a controller that calculates a passing probability in front of the shelf, based on the traffic line information, calculates a purchase probability of the item placed on the shelf, based on the purchased-item information, and calculates an evaluation value, of the item placed on the shelf, at a placement position, based on the passing probability and the purchase probability calculated.

### TECHNICAL FIELD

The present disclosure relates to an evaluation device and an evaluation method that evaluate a placement position of an item on a shelf.

### BACKGROUND ART

PTL 1 discloses a data analysis device that identifies positions of items by identifying the items included in a captured image and that analyzes a relationship between (i) a positional relationship between items and (ii) sales of the items on the basis of a relationship between the placement positions of the identified items and the sales data of the identified items. This arrangement makes it possible to provide highly useful information to optimally place the items.

### CITATION LIST

### Patent Literature

PTL 1: Unexamined Japanese Patent Publication No. 2016-48409

### SUMMARY

The present disclosure provides an evaluation device and an evaluation method that are effective for evaluating a placement position of an item.

An evaluation device according to the present disclosure evaluates a placement position of an item placed on a shelf in a shop, and the evaluation device includes: an obtaining unit that obtains traffic line information indicating a plurality of persons passing in front of the shelf and purchased-item information indicating one or more purchased items, the one or more purchased items being purchased in the shop by the plurality of persons; and a controller that calculates a passing probability in front of the shelf, based on the traffic line information, calculates a purchase probability of the item placed on the shelf, based on the purchased-item information, and calculates an evaluation value, of the item placed on the shelf, at a placement position, based on the passing probability and the purchase probability calculated.

In addition, an evaluation method according to the present disclosure is a method for evaluating a placement position of an item placed on a shelf in a shop, and the evaluation method includes: an obtaining step for obtaining traffic line information indicating a plurality of persons passing in front of the shelf and purchased-item information indicating one or more purchased items, the one or more purchased items being purchased in the shop by the plurality of persons; and a controlling step. The controlling step includes: calculating a passing probability in front of the shelf, based on the traffic line information; calculating a purchase probability of the item placed on the shelf, based on the purchased-item information; and calculating an evaluation value, of the item placed on the shelf, at a placement position, based on the passing probability and the purchase probability calculated.

The evaluation device and the evaluation method of the present disclosure are effective to evaluate a placement position of an item.

### BRIEF DESCRIPTION OF DRAWINGS

FIG. 1 is a block diagram showing a configuration of an evaluation device in a first exemplary embodiment and a second exemplary embodiment.

FIG. 2 is a diagram for describing relocation of items.

FIG. 3 is a flowchart for an overall operation in the first exemplary embodiment and the second exemplary embodiment.

FIG. 4 is a flowchart for describing calculation of a current evaluation value in the first exemplary embodiment and the second exemplary embodiment.

FIG. 5 is a diagram for describing purchased-item information and traffic line information.

FIG. 6 is a diagram for describing grouping.

FIG. 7 is a diagram for describing calculation of passing probabilities.

FIG. 8 is a diagram for describing calculation of purchase probabilities.

FIG. 9 is a flowchart, in the first exemplary embodiment, describing extraction of combinations of items and shelves that increase the evaluation values.

FIG. 10 is a diagram for describing items to be exchanged with each other in the first exemplary embodiment, where the exchange increases evaluation values of the items.

FIG. 11 is a flowchart, in the second exemplary embodiment, for describing extraction of combinations of items and shelves that increase evaluation values.

FIG. 12 is a diagram for describing a bipartite graph of the second exemplary embodiment.

### DESCRIPTION OF EMBODIMENTS

Hereinafter, exemplary embodiments will be described in detail with reference to the drawings as appropriate. However, an unnecessarily detailed description will not be given in some cases. For example, a detailed description of a well-known matter and a duplicated description of substantially the same configuration will be omitted in some cases. This is to avoid the following description from being unnecessarily redundant and thus to help those skilled in the art to easily understand the description. Note that the inventors provide the accompanying drawings and the following description to help those skilled in the art to well understand the present disclosure, but do not intend to use the drawings or the description to limit the subject matters of the claims.

### Problems

The sales prediction system in PTL 1 includes the above-described data analysis device and establishes a model for estimating the sales, and the sales prediction system predicts, by making the model perform machine learning, how the sales change in the case where a placement position of an item is changed. In order to cause such a model to machine learn, it is necessary to obtain sales data when an item is actually placed at various positions.

However, while the number of the types of items is large and the combination of the positional relationship between the items is enormous, the actual placement of the items in a shop is limited; therefore, it is difficult for the model to machine learn sufficiently. In addition, since the sales fluctuate depending on various factors, it is difficult to determine whether the change in the sales is caused by the relocation of the items. Therefore, even if machine learning is performed on the basis of the sales data, the change in the sales with respect to the placement of the items is not always learned.

As described above, it is difficult to determine the placement positions of items that increase sales, by the conventional method using the model having machine learned.

The present disclosure provides an evaluation device with which it is possible to accurately determine a placement position of an item that increases the sales. Specifically, the evaluation device of the present disclosure extracts, for better sales, such a placement position of an item that increases a chance of contact between shoppers and the item to be highly possibly purchased. For this purpose, the evaluation device of the present disclosure calculates, as an index of a chance of contact of shoppers with an item, evaluation values with respect to the placement position of the item placed on each of a plurality of shelves in a shop, on the basis of traffic line information of shoppers and purchased-item information. Then, the evaluation device extracts a combination of the item and a shelf that increases the evaluation value.

By changing the placement of an item on the shelf on the basis of the thus extracted combination, the chance of contact between shoppers and an item to be highly possibly purchased can be increased, whereby the sales of the shop can be increased.

Hereinafter, the present disclosure will be described in detail.

### First Exemplary Embodiment

### 1. Configuration

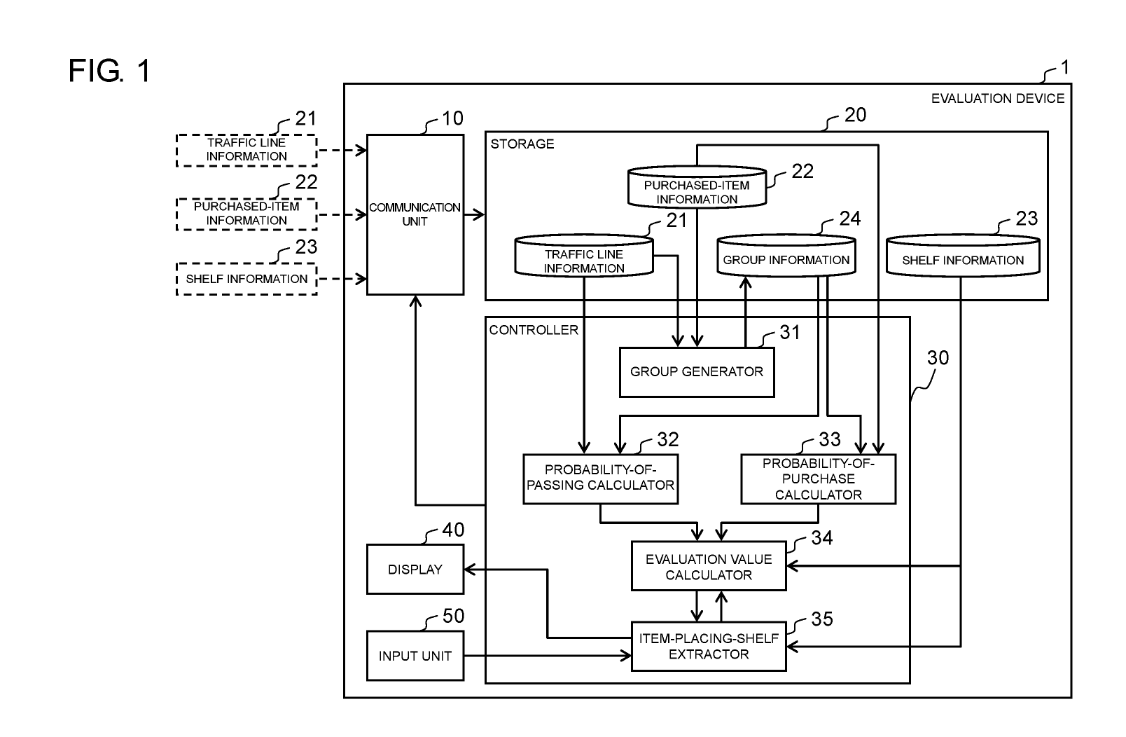

FIG. 1 shows a configuration of an evaluation device of the present exemplary embodiment. Evaluation device 1 of the present exemplary embodiment includes communication unit 10 that obtains various information from outside, storage 20 that stores obtained various information, controller 30 that controls whole of evaluation device 1, display 40, and input unit 50.

Communication unit 10 includes an interface circuit for communication with an external device, based on the predetermined communication standard, for example, LAN (Local Area Network) and WiFi. Communication unit 10 corresponds to an obtaining unit that obtains information from outside. Communication unit 10 obtains traffic line information 21 generated from a video of a camera installed in a shop or from other information. Traffic line information 21 is information representing flows of shoppers passing in front of each of the shelves in the shop. Traffic line information 21 includes, for example, dates and times when videos were taken, identification numbers (IDs) of the shoppers identified in a video, identification numbers (IDs) of the shelves that shoppers passed by, and a number of passing of shoppers in front of the shelves. Communication unit 10 further obtains purchased-item information 22 from a POS terminal device or other devices in the shop. Purchased-item information 22 is information representing items purchased in the shop. Purchased-item information 22 includes, for example, dates and times when items were purchased, the identification numbers (ID) of the purchased items, and numbers of purchased items. Communication unit 10 further obtains shelf information 23 representing the shelves on which items are currently placed. Shelf information 23 includes, for example, identification numbers (IDs) of items and identification numbers (IDs) of shelves.

Storage 20 stores traffic line information 21, purchased-item information 22, and shelf information 23 obtained via communication unit 10 and includes group information 24 to be generated by controller 30. Storage 20 is configured with, for example, a random access memory (RAM), a dynamic random access memory (DRAM), a ferroelectric memory, a flash memory, or a magnetic disk, or may be configured with a combination of these devices.

Controller 30 includes group generator 31, probability-of-passing calculator 32, probability-of-purchase calculator 33, evaluation value calculator 34, and item-placing-shelf extractor 35. Group generator 31 classifies shoppers into groups. Probability-of-passing calculator 32 calculates a passing probability that is a probability at which shoppers pass in front of a shelf. Probability-of-purchase calculator 33 calculates a purchase probability that is a probability at which an item is purchased. Evaluation value calculator 34 calculates an evaluation value with respect to a placement position of each item placed on each of the shelves in the shop. Item-placing-shelf extractor 35 extracts a combinations of an item and a shelf that increases an evaluation value.

In addition, controller 30 corresponds to an obtaining unit that obtains information stored in storage 20.

Controller 30 is configured with a semiconductor device and other devices. A function of controller 30 may be constituted only by hardware or may be realized by a combination of hardware and software. Controller 30 can be configured with, for example, a microcomputer, a central processor unit (CPU), a micro processor unit (MPU), a digital signal processor (DSP), a field-programmable gate array (FPGA), or an application specific integrated circuit (ASIC).

Group generator 31 classifies shoppers into a plurality of groups on the basis of traffic line information 21 and purchased-item information 22 and then generates group information 24 indicating which shopper belongs to which group. Group information 24 includes, for example, an identification number (ID), of each shopper, made to be associated with the group to which each shopper belongs. Group generator 31 stores generated group information 24 in storage 20.

Probability-of-passing calculator 32 calculates a passing probability for each group on the basis of traffic line information 21 and group information 24.

Probability-of-purchase calculator 33 calculates a purchase probability for each group on the basis of purchased-item information 22 and group information 24.

On the basis of the passing probability and the purchase probability for each group, evaluation value calculator 34 calculates the evaluation value (an index for evaluating the chance of contact between shoppers and an item) of the placement position of the item with respect to all the groups, in other words, for all the shoppers.

Item-placing-shelf extractor 35 extracts such a combination of an item and a shelf that increases the evaluation value in the case where the item is placed on a shelf other than the shelf on which the item is currently placed.

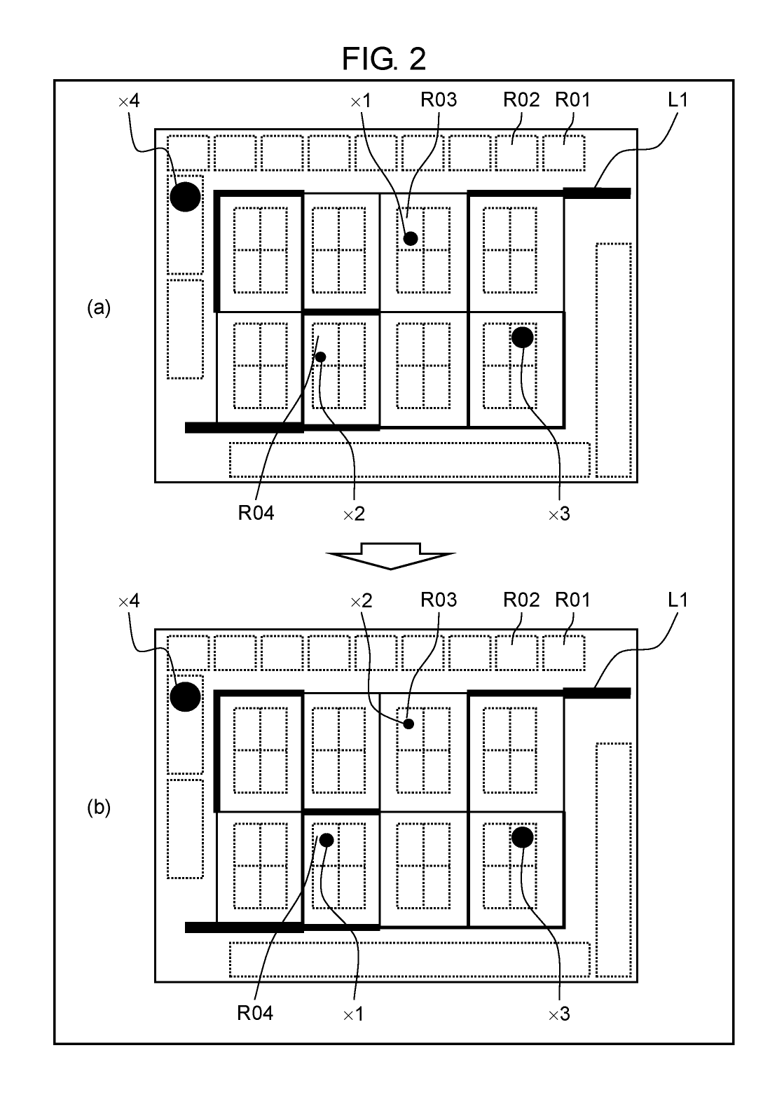

Display 40 displays, for example, a list of the extracted combinations of items and shelves, a layout chart showing current placement positions of items (see FIG. 2(a) to be described later), a layout chart when the placement positions of the items are changed in accordance with the extracted combinations (see FIG. 2(b) to be described later). Display 40 is, for example, a liquid crystal display or other displays.

Input unit 50 includes a keyboard, a mouse, a touch panel, and other devices and receives input to evaluation device 1 by a user. Input unit 50 corresponds to an obtaining unit that obtains information from outside.

FIG. 2(a) shows the current layout chart of the shop. FIG. 2(b) shows the layout chart of the shop in the case where the placement positions of the items are changed. As shown in FIG. 2(a), in the shop, a plurality of shelf R01, R02, R03, . . . are placed, and items are placed on the shelves. For example, in FIG. 2(a), item x1 is placed on shelf R03, and item x2 is placed on shelf R04. In the present exemplary embodiment, for example, controller 30 extracts, on the basis of the evaluation values, the combination of item x1 and shelf R04 and the combination of item x2 and shelf R03. For example, after extracting the combination, controller 30 causes display 40 to display, side by side, the current layout chart of the shop as shown in FIG. 2(a) and the layout chart of the shop as shown in FIG. 2(b) when the placement positions of the items are changed.

The sizes of the circular shapes representing items x1, x2, x3, x4 represent the purchase probabilities of the items. For example, the circular shape with a larger size indicates that the purchase probability is higher. The thickness of traffic line L1 of shoppers indicates a passing probability. For example, the thicker traffic line L1 indicates the higher frequency at which shoppers pass. For example, controller 30 determines, on the basis of traffic line information 21, a position and a thickness of traffic line L1 and causes display 40 to display traffic line L1. In addition, on the basis of purchased-item information 22, controller 30 determines the sizes of the circular shapes representing items x1, x2, x3, x4, and causes display 40 to display the circular shapes representing items x1, x2, x3, x4.

It can be considered that the items to be purchased by shoppers include items to be purchased regardless of the placement positions in the shop and include items whose possibilities to be purchased depend on the placement positions in the shop. The items to be purchased regardless of the placement positions in the shop are items strongly linked to a visiting motivation. The items whose possibilities to be purchased depend on the placement positions in the shop are loosely linked to a visiting motivation.

Regarding the items strongly linked to a visiting motivation, the probabilities of being purchased are high even if the items are not relocated to the positions that increase chances of contact. Therefore, in the present exemplary embodiment, the item strongly linked to a visiting motivation (for example, item x4 whose purchase probability is higher than a predetermined value) is not an object to be relocated.

On the other hand, regarding the items loosely linked to a visiting motivation, it is considered that when the items get relocated to the positions where chances of contact are higher, the probabilities of being purchased become higher. Therefore, in the present exemplary embodiment, the items loosely linked to a visiting motivation (for example, items x1, x2, x3 having purchase probabilities smaller than the predetermined value) is dealt as the objects to be relocated, and alternative shelves are extracted.

### 2. Operation

### 2. 1 Overall Operation

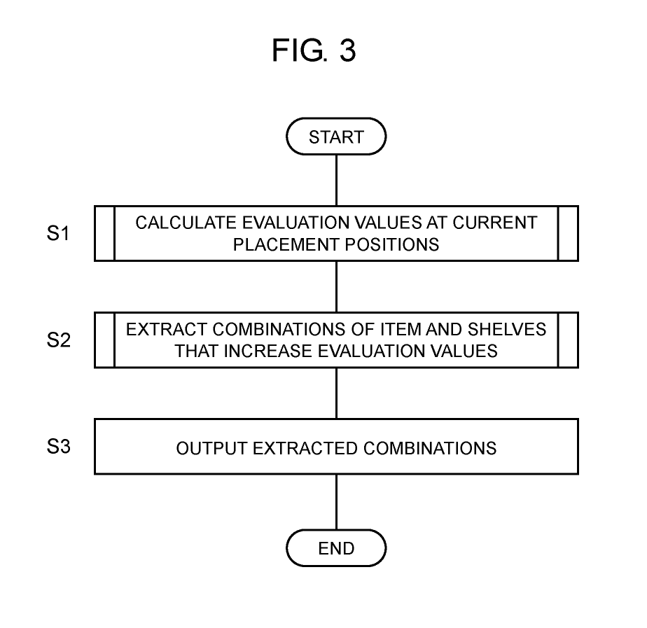

FIG. 3 shows an overall operation of controller 30. Controller 30 first calculates the evaluation value of each item with respect to the current placement positions of the item on the basis of traffic line information 21 and purchased-item information 22 (S1). Next, controller 30 extracts the combinations of items and shelves with which the evaluation values are larger than the current evaluation values (S2). Finally, controller 30 outputs the extracted combinations (S3).

Controller 30 may display results of the extracted combinations on display 40, may store the results as shelf information 23 in storage 20, or may output the results to outside via communication unit 10. The user can consider replacement of actual items while watching the output results.

### 2. 2 Calculation of Evaluation Values at Current Placement Positions

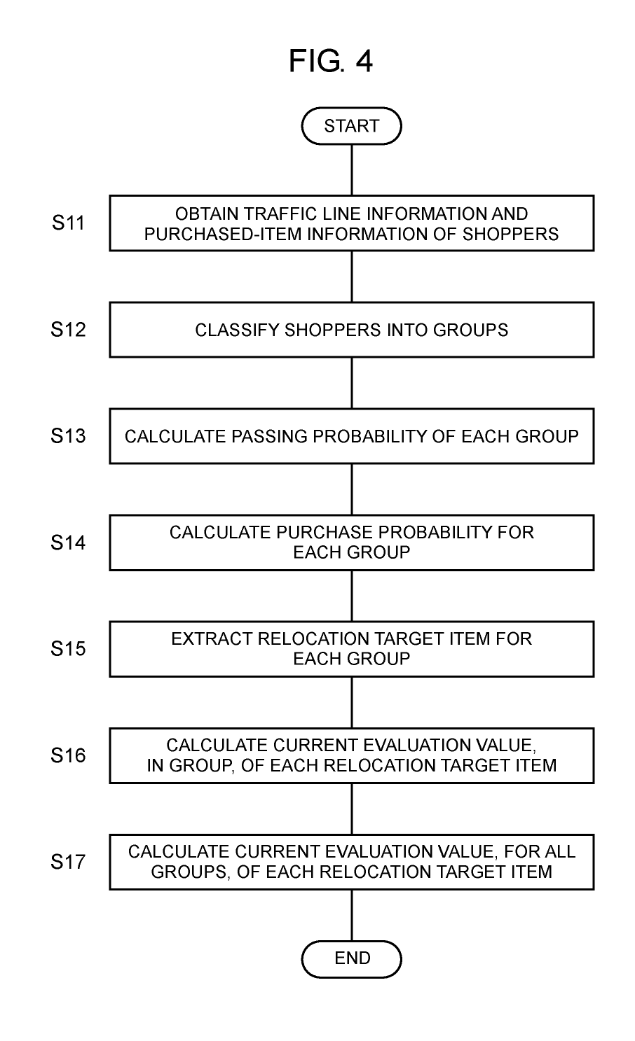

FIG. 4 shows in detail how to calculate the evaluation values at the current placement positions (step S1 of FIG. 3). Group generator 31 first obtains traffic line information 21 and purchased-item information 22 of shoppers from storage 20 (S11).

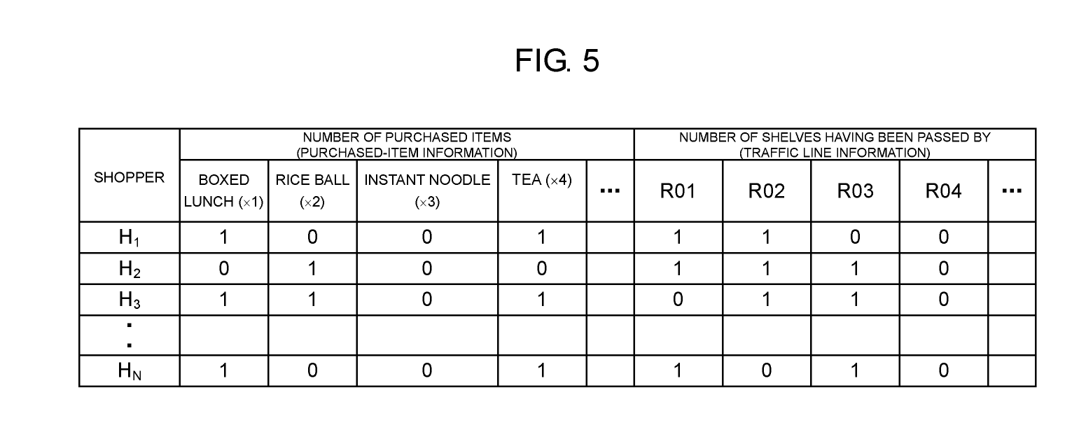

FIG. 5 shows an example of traffic line information 21 and purchased-item information 22. Traffic line information 21 and purchased-item information 22 are associated with each other by the identification numbers (H₁, H₂, H₃, . . . , H_{N}) of shoppers or the like. For example, because the time when a shopper is at a cash desk and the time when the input of the purchased item is completed at the cash desk almost coincide with each other, controller 30 may associate traffic line information 21 with purchased-item information 22 on the basis of the date and time contained in traffic line information 21 and the date and time contained in purchased-item information 22. Alternatively, controller 30 may obtain from outside, via communication unit 10, traffic line information 21 and purchased-item information 22 that are associated with each other by, for example, the identification numbers of shoppers, and controller 30 may store obtained traffic line information 21 and purchased-item information 22 in storage 20.

Group generator 31 classifies the shoppers into a plurality of groups gᵢ (i=1 to 20, for example) on the basis of traffic line information 21 of shoppers and purchased-item information 22 (step S12 of FIG. 4). Specifically, for example, group generator 31 classifies the shoppers into groups on the basis of traffic line information 21 and purchased-item information 22 for a predetermined period (for example, one month) by using the multimodal Latent Dirichlet Allocation (LDA).

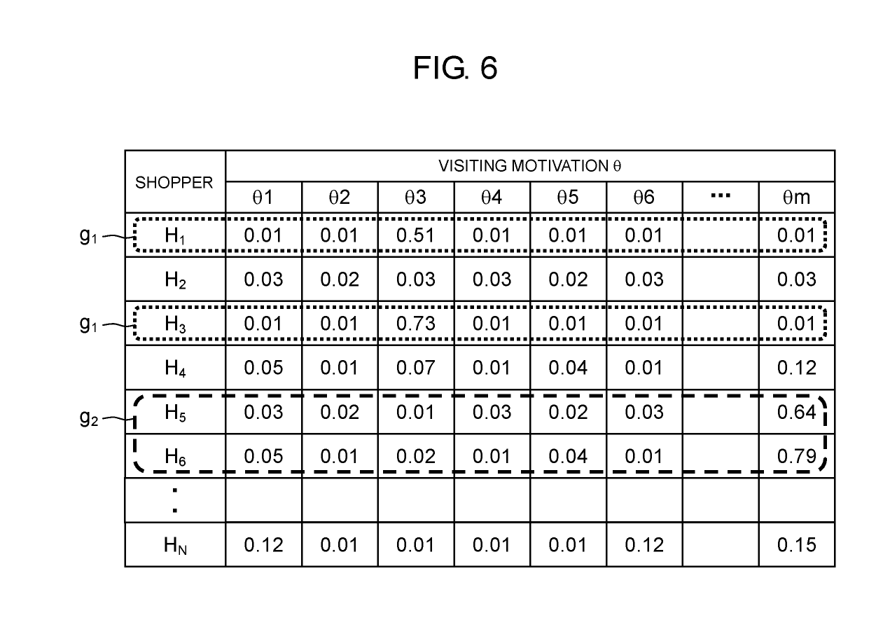

FIG. 6 shows the result of the grouping by using the multimodal LDA. Characteristics of the shoppers are expressed by m-dimensional vectors (for example, m=20). The m-dimensional grouping based on the traffic line information 21 and purchased-item information 22 corresponds to the grouping based on a visiting motivations θ1 to θm. In the present exemplary embodiment, group generator 31 classifies the shoppers into groups on the basis of similarity among the vectors of the visiting motivations θ1 to θm. For example, group generator 31 performs grouping on the basis of the largest numerical value in the vector expression of each shopper. In this case, for each of the shoppers H₁ and H₃, the numerical value of the visiting motivation θ3 is the largest of the visiting motivations θ1 to θm, and the numerical values of the other visiting motivations are small, so that the shoppers H₁ and H₃ are in the same group g₁. In addition, for each of the shoppers H₅ and H₆, the numerical value of the visiting motivation θm is the largest, and the numerical values of the other visiting motivations are small, so that the shoppers 115 and H₆ are in the same group g₂. Group generator 31 generates group information 24 indicating which shopper is in which group and stores group information 24 in storage 20.

Probability-of-passing calculator 32 calculates passing probabilities P(r|gᵢ) of each group on the basis of traffic line information 21 and group information 24 (step S13 of FIG. 4).

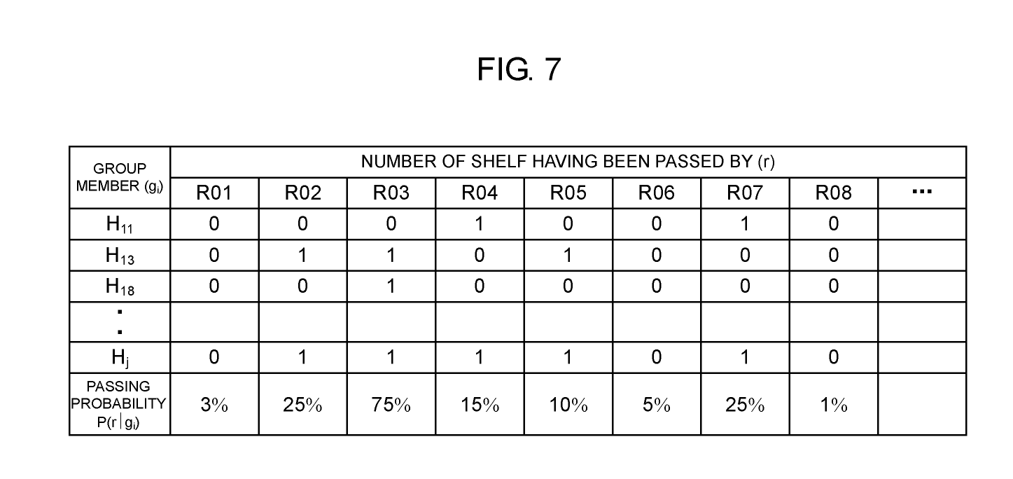

FIG. 7 shows the shelf numbers r (r=R01, R02, R03, . . . ) of the shelves that shoppers in a certain group gᵢ passed by and the passing probabilities P(r|gᵢ), of the group, for each shelf. In FIG. 7, the case where a shopper passed once or more in front of a shelf r is indicated by “1”, and the case where a shopper did not pass at all is indicated by “0”. Probability-of-passing calculator 32 calculates the passing probability P(r|gᵢ) on the basis of, for example, the number of persons having passed. In this case, the passing probability P(r|gᵢ) is h/n. Here, h represents the number of persons having passed in front of the shelf r, and n represents the number of the persons in the group.

Probability-of-purchase calculator 33 calculates the purchase probabilities P(x|gᵢ) for each group on the basis of purchased-item information 22 and group information 24 (step S14 of FIG. 4).

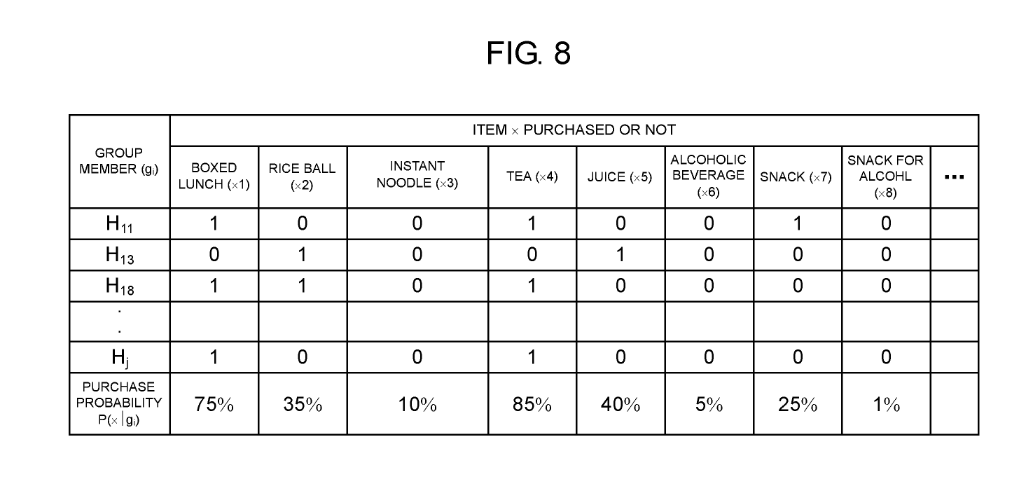

FIG. 8 shows the items x (x=boxed lunch, rice ball, instant noodle, . . . ) that the shoppers in a certain group gᵢ purchased and the purchase probabilities P(x|gᵢ), of the group, for respective items. In FIG. 8, the case where a shopper purchased one or more items x is represented by “1”, and the case where a shopper did not purchase an item at all is represented by “0”. Probability-of-purchase calculator 33 calculates the purchase probabilities P(x|gᵢ) on the basis of, for example, the number of persons having purchased an item. In this case, the purchase probabilities P(x|gᵢ) are k/n. Here, k represents the number of the persons having purchased the item x, and n represent the number of the persons in the group.

Evaluation value calculator 34 extract the relocation target item with respect to each group, on the basis of the purchase probabilities (step S15 of FIG. 4). Specifically, the item whose purchase probabilities P(x|gᵢ) are less than or equal to a predetermined value (for example, ⅓ of the maximum purchase probability in each group) with respect to all the groups is extracted as the relocation target item. Note that the threshold value used to determine whether an item is the relocation target item may be a variable value, depending on groups and items. For example, an item whose purchase probability is lower than the value calculated by multiplying by a constant (for example, 0.5) the purchase probability of the item whose purchase probability is the highest with respect to the group gᵢ may be dealt with as an object to be relocated. By taking this measure, it is possible to select as a relocation target item an object that is appropriate for two groups. In one of the groups, some items are intensively purchased, and in the other group, some items are not intensively purchased.

Evaluation value calculator 34 reads out shelf information 23 from storage 20, and then calculates, from the purchase probability P(x|gᵢ), for the group gᵢ, of the item x and from the passing probability P(r|gᵢ) of the shelf r, an evaluation value Vᵢ (x, r₀(x)), for the group gᵢ, with respect to shelf r₀(x) on which the item is currently placed, for each item x (x=x1, x2, x3, . . . ) to be relocated, on the basis of the following Equation (1) (step S16 of FIG. 4).

Vᵢ(x,r)=P(x|gᵢ)P(r|gᵢ) Equation (1)

where the shelf r is the current shelf r₀(x).

In addition, evaluation value calculator 34 calculates the current evaluation value V(x, r₀(x)), for all the groups, of each relocation target item, based on the following Equation (2) (step S17 of FIG. 4).

V(x,r)=ΣᵢP(gᵢ)Vᵢ(x,r) Equation (2)

where the shelf r is the current shelf r₀(x). Further, P(gᵢ) is n/N (the proportion of the number n of the persons in the group gᵢ to the total number N of the persons in all the groups).

2.3 Extraction of Combinations of Items and Shelves

Next, the placement positions, of the items, for better sales are extracted on the basis of the evaluation values. Hereinafter, a case will be described as an example. In the case, when an item (for example, item x1) is relocated from the current shelf (for example, shelf R01) to another shelf (for example, shelf R02), an item (for example, item x2) placed on the another shelf (for example, shelf R02) after the relocation needs to be relocated to still another shelf (for example, shelf R03 or shelf R01).

Specifically, in the exemplary embodiment, a description will be given on the case where two items placed on different shelves are replaced with each other.

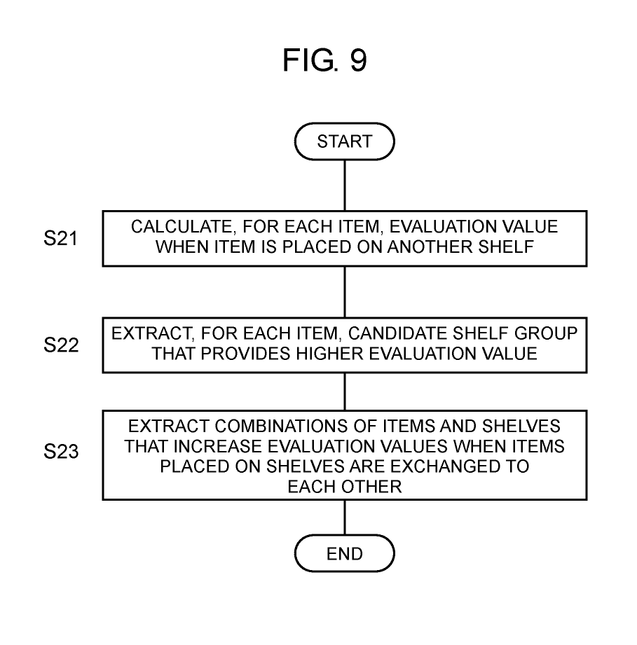

FIG. 9 shows details of the extraction (step S2 of FIG. 3) of combinations of items and shelves that increase evaluation values. First, on the basis of the above Equations (1) and (2), evaluation value calculator 34 calculates the evaluation value V(x, r), of each item x (x=x1, x2, x3, . . . ) that is extracted in step S15 of FIG. 4 as a relocation target item, for all the groups when the item is placed on another shelf r that is different from the current shelf r₀(x) (for example, the shelf r is each of all the shelves in the shop except the current shelf r₀) (S21).

Here, if the position of an item strongly linked to a visiting motivation is changed, the passing probabilities P(r|gᵢ) may be changed. However, in the present exemplary embodiment, the relocation target items are limited to the items loosely linked to the visiting motivation, and the passing probabilities P(r|gᵢ) are therefore calculated assuming the passing probabilities are constant regardless of positions of items.

Item-placing-shelf extractor 35 extracts, by the following Equation (3), a candidate shelf group R(x) for which the evaluation value V(x, r) calculated for each relocation target item x (x=x1, x2, x3, . . . ) is larger than the current evaluation value V(x, r₀(x)) (S22).

R(x)={r|V(x,r)>V(x,r₀(x)),r∈R} Equation (3)

Further, item-placing-shelf extractor 35 extracts combinations of items and shelves that increase evaluation values when items placed on the shelves are exchanged (S23).

Specifically, as shown by the following Equation (4), when the current shelf r₀(xₐ) of the item xₐ is included in the candidate shelf group R(x_{b}) that increases the evaluation value of the item x_{b}) and when the current shelf r₀(x_{b}) of the item x_{b} is included in the candidate shelf group R(xₐ) that increases the evaluation value of the item xₐ, the combination of the item xₐ and the shelf r₀(x_{b}) and the combination of the item x_{b} and the shelf r₀(xₐ) are extracted. That is, the item xₐ and the item x_{b} are extracted as the combination of items to be exchanged whose evaluation values increase.

r₀(xₐ)∈R(x_{b}) and r₀(x_{b})∈R(xₐ) Equation (4)

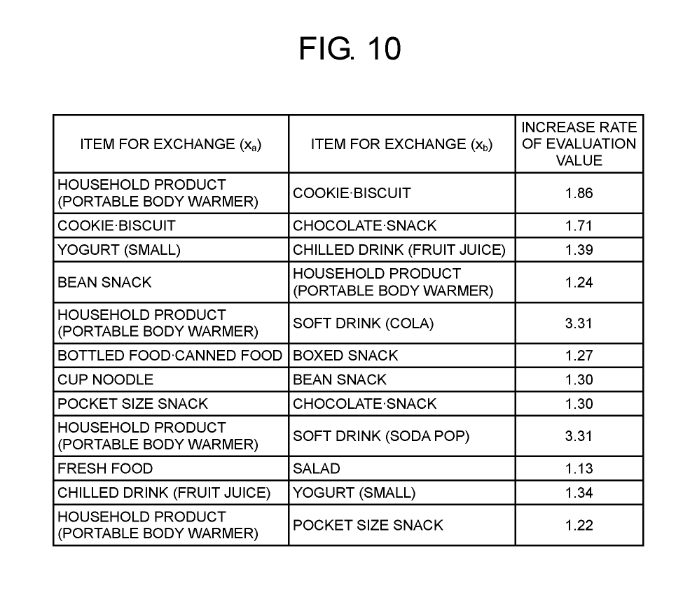

FIG. 10 shows combinations each of which includes items whose evaluation values increase when the items are exchanged (the items are, for example, the item xₐ and the item x_{b}). In FIG. 10, the increase rate of the evaluation value represents an average value of the increase rate of the evaluation value of the item xₐ and the increase rate of the evaluation value of the item x_{b}.

Item-placing-shelf extractor 35 may output on display 40, for example, a list of the extracted results as shown in FIG. 10 in the step of outputting the combinations (step S3 of FIG. 3). Alternatively, it is also possible to display the item x_{b} capable of being exchanged with the item xₐ on a screen of display 40 if the item xₐ is selected by a user via input unit 50 when a layout chart of the shop as shown in FIG. 2(a) is being displayed on display 40.

### 3. Effects and the Like

Evaluation device 1 of the present disclosure evaluates a placement position of an item placed on a shelf in a shop, and evaluation device 1 includes: the obtaining unit (communication unit 10 or controller 30) that obtains traffic line information 21 indicating a plurality of persons (shoppers) passing in front of the shelf and purchased-item information 22 indicating items purchased in the shop by the plurality of persons; and controller 30 that calculates a passing probability in front of the shelf, based on traffic line information 21, calculates a purchase probability of the item, based on purchased-item information 22, and calculates an evaluation value V(x, r), of the item, of a placement position, based on the passing probability and the purchase probability calculated.

The thus calculated evaluation value V(x, r) can be used as an index of the chance of contact between shoppers and an item. That is, by using the evaluation value V(x, r), it is possible to determine such placement positions of an item that increase the chance of contact between shoppers and the item to be highly possibly purchased. As a result, the sales of the shop can be increased.

On the basis of the passing probability for each of a plurality of shelves that are in the shop and includes the shelf r₀ (x) on which an item is currently placed and on the basis of the purchase probability of the item, controller 30 calculates the evaluation value V(x, r) when the item is placed on each of the shelves in the shop (step S17 of FIG. 4 and step S21 of FIG. 9). Then, controller 30 extracts, from the plurality of shelves, another shelf r that increases the evaluation value than the shelf r₀(x) on which the item is currently placed, as the candidate shelf group R(x) (R(x)={r|V(x, r)>V(x, r₀(x)), r∈R}).

Extracting another shelf r that increases the evaluation value V(x, r) corresponds to determining such a placement position of an item that increases the chance of contact between a shopper and an item to be highly probably purchased. Evaluation device 1 of the present disclosure can provide information of a placement position of an item, and the placement position can increase the sales of the shop.

Controller 30 calculates an evaluation value for each of a plurality of items each of which is placed on a different shelf in a shop, and extracts a combination of at least two items from the plurality of items if the evaluation value of each of the two items (xₐ, x_{b}) increases when the at least two items (xₐ, x_{b}) of the plurality of items are exchanged with each other. By this, exchange between the item xₐ and the item x_{b} can be proposed.

Controller 30 extracts another shelf for an item whose purchase probability is smaller than or equal to a predetermined value. By this, it is possible to propose relocation of the item loosely linked to a visiting motivation to such a position that increases a chance of contact.

Controller 30 classifies a plurality of persons (shoppers) into a plurality of groups on the basis of traffic line information 21 and purchased-item information 22. In addition, on the basis of traffic line information 21 of the persons in each of the plurality of groups, controller 30 calculates a passing probability P(r|gᵢ) for each group. Then, on the basis of purchased-item information 22 of the persons in each of the plurality of groups, controller 30 calculates a purchase probability P(x|gᵢ) for each group. Further, on the basis of the passing probability P(r|gᵢ) and the purchase probability P(x|gᵢ) both for each group, controller 30 calculates the evaluation value V(x, r) with respect to all the plurality of persons (all the group, in other words, all the shoppers).

Specifically, the evaluation value V(x, r) with respect to all the plurality of persons is a total value of a value obtained by multiplying a proportion P(gᵢ) of the number of persons in each group to a total number of the plurality persons (shoppers), the purchase probability P(x|gᵢ) for each group, and the passing probability P(r|gᵢ) for each group, and is expressed by the following Equation (5).

V(x,r)=ΣᵢP(gᵢ)P(x|gᵢ)P(r|gᵢ) Equation (5)

By grouping on the basis of traffic line information 21 and purchased-item information 22, the shoppers whose visiting motivation are similar can be classified into the same group. Since the calculations of the passing probability and the purchase probability are for each group in which the visiting motivation is similar, the accuracy of the evaluation value Vᵢ (x, r) in each group is higher. By this, the evaluation value V(x, r) with respect to all the shoppers can be increased.

Note that although the combination is extracted for the placement positions of the two items xₐ and x_{b} in the first exemplary embodiment, shelves can also be exchanged for three or more items. For example, if the following equations are satisfied, shelves for three items can be exchanged.

r₀(x₁)∈R(x₂)

r₀(x₂)∈R(x₃)

r₀(x₃)∈R(x₁)

where r₀(x) represents the shelf on which the item is currently placed, and R(x) represents a candidate shelf group that increases the evaluation value.

### Second Exemplary Embodiment

In the present exemplary embodiment, there will be described another example of how to extract a combination of an item and a shelf that increases an evaluation value. The extraction of a combination of an item and a shelf according to the first exemplary embodiment is effective when there are a few relocation target items.

In the present exemplary embodiment, a description will be given on a method for extracting a combination of an item and a shelf that is effective when there are many relocation target items. Evaluation device 1 of the present exemplary embodiment has a configuration shown in FIG. 1.

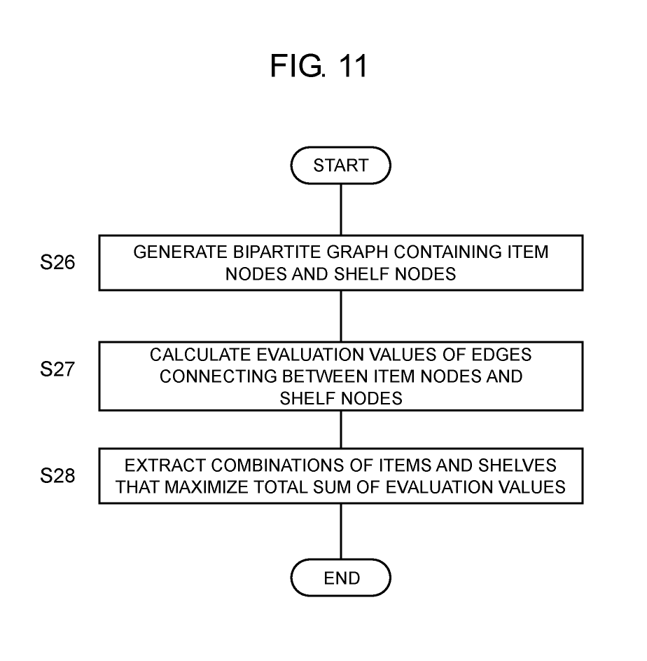

FIG. 11 illustrates, in detail, extraction (step S2 of FIG. 3) of a combination of an item and a shelf that increases an evaluation value in the second exemplary embodiment. Item-placing-shelf extractor 35 generates a bipartite graph containing item nodes and shelf nodes, on the basis of shelf information 23 (S26).

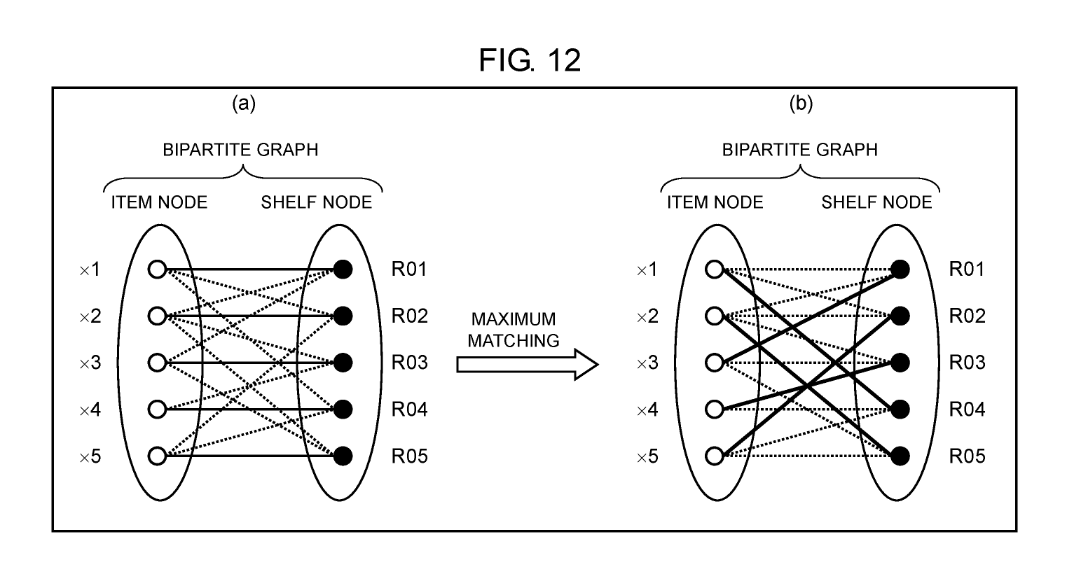

FIG. 12(a) shows an example of the bipartite graph. The item nodes (x=x1, x2, x3, . . . ) correspond all or a part (for example, items placed on different shelves) of the relocation target items (items extracted in step S15 of FIG. 4). The shelf nodes (r=R01, R02, R03, . . . ) correspond to the shelves in the shop. In FIG. 12(a), the solid line edges between the item nodes and the shelf nodes indicate shelves R01 to R05 on which items x1 to x5 are currently placed. The information for identifying the shelves on which relocation target items are currently placed is obtained from shelf information 23.

The solid line edges are generated by evaluation device 1 on the basis of shelf information 23. The broken line edges indicate shelves R01 to R05 on which items x1 to x5 can be placed. The broken line edges are generated by a user through input unit 50. Alternatively, regarding each of the items in the shop, evaluation device 1 may obtain, via communication unit 10 or input unit 50, information (placement possibility information) indicating at least one shelf on which the item can be placed or at least one shelf on which the item cannot be placed, and evaluation device 1 may store the information in storage 20. In this case, item-placing-shelf extractor 35 may obtain the placement possibility information from storage 20 to generate the broken line edges.

Evaluation value calculator 34 calculates, using above Equation (2), the evaluation value V(x, r) with respect to the combination of the items x and the shelves r that are connected to each other by the broken line edge (step S27 of FIG. 11). Note that the evaluation value V(x, r) (in this case, r=r₀(x)) with respect to the combination between the items x and the shelves r that are connected to each other by the solid line edges is already calculated in step S17 of FIG. 4.

Item-placing-shelf extractor 35 extracts a combination of items and shelves that maximizes a total of weights of the edges (in other words, a total sum of evaluation values V(x, r)) by solving a maximum-weight maximum-matching problem of the bipartite graph, using the evaluation values V(x, r) as weights of the edges (step S28 of FIG. 11).

Here, “to solve a maximum matching problem” is generally to connect between nodes of a bipartite graph with as many non-duplicated edges as possible without considering the score of the edges. In the present specification, “to solve a maximum-weight maximum-matching problem” is to solve a maximum matching problem, considering the weights given to the edges, so that the sum of the weights is maximized.

FIG. 12(b) shows, by the solid line edges, an example of the extracted combination of items and shelves. As shown in FIG. 12(b), item-placing-shelf extractor 35 extracts a combination of an item and a shelf in such a manner that each item node is connected to any one different shelf node.

As described above, in evaluation device 1 of the present disclosure, controller 30 calculates the evaluation value V(x, r) for each of the items placed on different shelves in the shop, and extracts the combination of items and shelves that maximizes the total sum of the evaluation values V(x, r) with respect to the placement positions to which a plurality of items will have been placed in a case where the plurality of items will be relocated to each other. By this, it is possible to propose such placement positions of items that increase the chances of contact between shoppers and items to be highly possibly purchased. Therefore, it is possible to increase the sales of the shop.

### Other Exemplary Embodiments

In the above, the first and second exemplary embodiments have been described as techniques disclosed in the present application. IHowever, the techniques in the present disclosure are not limited to the above exemplary embodiments and are applicable to exemplary embodiments in which changes, replacements, additions, omissions, or the like are made as appropriate. Further, the components described in the above first and second exemplary embodiments can be combined to configure a new exemplary embodiment.

Therefore, other exemplary embodiments will be illustrated below.

In the above first and second exemplary embodiments, the description is given on the case where evaluation device 1 obtains traffic line information 21 from outside via communication unit 10. However, traffic line information 21 does not have to be obtained from outside. For example, evaluation device 1 may acquire a video taken by a camera installed in the shop via communication unit 10. Then, the acquired video may be analyzed by controller 30 to generate traffic line information 21 indicating the shelves that shoppers passed by, and traffic line information 21 may be stored in storage 20. Similarly, evaluation device 1 may make controller 30 analyze the obtained video to generate shelf information 23 indicating the shelves on which items are currently placed, and may store shelf information 23 in storage 20.

In the above first and second exemplary embodiments, the described grouping uses the multimodal LDA. However, the grouping does not have to use the multimodal LDA. Any method can be uses if the method performs grouping, using traffic line information 21 and purchased-item information 22. For example, the grouping may be performed, using a method called non-negative tensor factorization, the unsupervised learning using neural network, or the clustering method (such as the K-means method).

In the above first and second exemplary embodiment, the passing probability P(r|gᵢ) is calculated on the basis of the number of persons having passed in front of the shelf. However, the passing probability P(r|gᵢ) may be calculated by other methods. For example, the passing probability P(r|gᵢ) may be calculated on the basis of the times a shopper passed in front of the shelf. In this case, the passing probability P(r|gᵢ) is f/F calculated by dividing the times f all the members of a group passed in front of the shelf r by the total times F all the member of the group passed by all the shelves.

Alternatively, the passing probability P(r|gᵢ) may be calculated on the basis of the time period when a shopper stayed in front of the shelf. In this case, the passing probability P(r|gᵢ) is t/T. Note that t represents the time period when all the members of a group stayed in front of the shelf r, and T represents the total time period when all the members of the group stayed in front of any of the shelf r.

In the above first and second exemplary embodiments, the purchase probability P(x|gᵢ) is calculated on the basis of the number of persons having purchased items. However, the purchase probability P(x|gᵢ) may be calculated by other methods. For example, the purchase probability P(x|gᵢ) may be calculated on the basis of the number of purchased items. In this case, the purchase probability P(x|gᵢ) is w/W calculated by dividing the number w of the items x purchased by all the member of a group by the total number W of the items purchased by all the members of the group.

In the above first and second exemplary embodiments, the items loosely linked to a visiting motivation are considered to be the relocation target items. However, the relocation target items do not have to be items loosely linked to a visiting motivation. For example, all the items in the shop can be considered to be relocation target items. In this case, step S15 of FIG. 4 may be omitted.

In the above first and second exemplary embodiments, the description is given on the case where a plurality of items are exchanged with each other. However, evaluation device 1 of the present disclosure can also be applied to the case where items are not exchanged but an item is just moved to another shelf. For example, item-placing-shelf extractor 35 may extract, in step S2 of FIG. 3, the shelf r that maximizes an increase rate of the evaluation value V(x, r) with respect to the relocation target item x.

Evaluation device 1 of the present disclosure can be configured with, for example, cooperation between hardware resources such as a processor and a memory, and a program.

As described above, the exemplary embodiments have been described as examples of the techniques in the present disclosure. For this purpose, the accompanying drawings and the detailed description are provided. Therefore, in order to illustrate the above techniques, the components described in the accompanying drawings and the detailed description can include not only the components necessary to solve the problem but also components unnecessary to solve the problem. For this reason, it should not be immediately recognized that those unnecessary components are necessary just because those unnecessary components are described in the accompanying drawings or the detailed description.

In addition, because the above exemplary embodiments are for illustrating the techniques in the present disclosure, various modifications, replacements, additions, omissions, or the like can be made without departing from the scope of the accompanying claims or the equivalent thereof.

### INDUSTRIAL APPLICABILITY

The evaluation device of the present disclosure enables evaluation of the placement positions of items; therefore, the evaluation device is useful for various devices that provide users with information of such placement positions of items that increase the sales.

### REFERENCE MARKS IN THE DRAWINGS

1 evaluation device
10 communication unit (obtaining unit)
20 storage
30 controller
31 group generator
32 probability-of-passing calculator
33 probability-of-purchase calculator
34 evaluation value calculator
35 item-placing-shelf extractor
40 display
50 input unit

1. An evaluation device that evaluates a placement position of an item placed on a shelf in a shop, the evaluation device comprising:
an obtaining unit that obtains traffic line information indicating a plurality of persons passing in front of the shelf and purchased-item information indicating one or more purchased items, the one or more purchased items being purchased in the shop by the plurality of persons; and
a controller that calculates a passing probability in front of the shelf, based on the traffic line information, calculates a purchase probability of the item placed on the shelf, based on the purchased-item information, and calculates an evaluation value, of the item placed on the shelf, at a placement position, based on the passing probability and the purchase probability calculated.

2. The evaluation device according to claim 1, wherein the controller calculates, based on the passing probability for each of a plurality of shelves that are in the shop and include the shelf on which the item is currently placed and based on the purchase probability of the item, the evaluation value when the item is placed on each of the plurality of shelves in the shop, and extracts from the plurality of shelves, another shelf that provides greater evaluation value than the shelf on which the item is currently placed.

3. The evaluation device according to claim 2, wherein the controller calculates the evaluation value for each of a plurality of items placed on different shelves in the shop, the plurality of items including the item placed on the shelf, and extracts a combination of at least two items from the plurality of items, the combination increasing the evaluation value of each of the at least two items when the at least two items of the plurality of items are exchanged with each other.

4. The evaluation device according to claim 2, wherein the controller calculates the evaluation value for each of a plurality of items placed on different shelves in the shop, and extracts a combination of items and shelves that maximizes a total sum of the evaluation values with respect to placement positions to which the plurality of items will have been placed in a case where the plurality of items will be relocated to each other.

5. The evaluation device according to claim 2, wherein the controller extracts another shelf for an item whose purchase probability is smaller than or equal to a predetermined value.

6. The evaluation device according to claim 1, wherein
the controller
classifies the plurality of persons into a plurality of groups, based on the traffic line information and the purchased-item information,
calculates, based on the traffic line information of a person or persons in each of the plurality of groups, the passing probability for each group,
calculates, based on the purchased-item information of the person or persons in each of the plurality of groups, the purchase probability for each group, and
calculates, based on the passing probability and the purchase probability both for each group, the evaluation value with respect to all the plurality of persons.

7. The evaluation device according to claim 6, wherein the evaluation value with respect to all the plurality of persons is a total value of a value obtained by multiplying a proportion of a number of the person or persons in each group to a total number of the plurality of persons by the purchase probability and the passing probability both for each group.

8. An evaluation method for evaluating a placement position of an item placed on a shelf in a shop, the evaluation method comprising:
an obtaining step for obtaining traffic line information indicating a plurality of persons passing in front of the shelf and purchased-item information indicating one or more purchased items, the one or more purchased items being purchased in the shop by the plurality of persons; and
a controlling step including:
calculating a passing probability in front of the shelf, based on the traffic line information;
calculating a purchase probability of the item placed on the shelf, based on the purchased-item information; and
calculating an evaluation value, of the item placed on the shelf, at a placement position, based on the passing probability and the purchase probability calculated.

9. The evaluation method according to claim 8, wherein in the controlling step, based on the passing probability for each of a plurality of shelves that are in the shop and include the shelf on which the item is currently placed and based on the purchase probability of the item, the evaluation value when the item is placed on each of the plurality of shelves in the shop is calculated, and another shelf that provides a greater evaluation value than the shelf on which the item is currently placed is extracted from the plurality of shelves.
